(19) United States
(12) Patent Application Publication
(10) Pub. No.: US 2026/0042409 A1
(43) Pub. Date: Feb. 12, 2026

(54) IMPACT-ABSORBING ELEMENT AND ASSEMBLY METHOD

(71) Applicant: MAGNA INTERNATIONAL INC., Aurora (CA)

(72) Inventors: Jens RETHFELDT, Haibach (DE); Lukas HAFENSCHER, Hollenthon (AT)

(21) Appl. No.: 19/282,162

(22) Filed: Jul. 28, 2025

(30) Foreign Application Priority Data
Aug. 7, 2024 (DE) 102024122462.2

(51) Int. Cl. B60R 19/26

(52) U.S. Cl. CPC B60R 19/26

(57) ABSTRACT

An impact-absorbing element for a motor vehicle that absorbs energy in a collision includes a metal tube forming a hollow chamber closed at the ends by a mounting plate and an end wall. A plurality of inserts made of energy-absorbing plastic are disposed within the hollow chamber and placed axially between the mounting plate and the end wall.

### CROSS REFERENCE TO RELATED APPLICATIONS

This U.S. Non-Provisional Patent Application claims the benefit of DE Patent Application No. 10 2024 122 462.2, filed Aug. 7, 2024 the contents of which are incorporated herein by reference in its entirety.

### FIELD

The invention relates to an impact-absorbing element for a motor vehicle that absorbs energy in a collision, which has a hollow metal tube closed by a mounting plate on one end and a wall at the back.

The invention also relates to a method for the assembly of this impact-absorbing element.

### BACKGROUND

Bumpers are placed on each end of a motor vehicle covered by a plastic shell on the vehicle's frame. Deformation and impact-absorbing elements are integrated therein to prevent damage to the vehicle body caused by low-speed impacts to the front or rear of the vehicle. Impact-absorbing elements are normally thin-walled rectangular elements made of steel, aluminum or plastic. They can be produced by joining pieces of sheet metal or in an aluminum extrusion process.

Located between the chassis and the bumper, these impact-absorbing elements absorb the kinetic energy generated in a collision. This is intended to protect the chassis from permanent damage when exceeding a critical load. These impact-absorbing elements are typically fit to the shape of the vehicle and its specific requirements. They must also comply with various legal requirements, taking the weight of the vehicle and the strength of the materials into account. The impact-absorbing elements are therefore tailored individually to each type of vehicle. These impact-absorbing elements can ideally absorb as much energy as possible, without adding much weight to the vehicle.

There are impact-absorbing elements in the prior art. WO2012040826 A1 discloses a scalable impact-absorbing element with a decagonal cross section. This impact-absorbing element is symmetrical in relation to a central axis.

Depending on the requirements for the vehicle in question, thick walls and elongated boxes can be used in the crash management system. Moreover, due to structural limitations, an efficiency of “only” 90% can be obtained. If steel is used, thicker walls are heavier, and aluminum is expensive. It is impossible to reach an energy dissipation efficiency of 100%.

Specifically for rail vehicles, a combination of materials is used.

EP 2 072 370 A1 discloses shock absorbers that contain regenerative dampers for the impacts and tensile forces occurring during normal operation of the vehicle, and a non-regenerative buffer element that converts at least part of the force of the impact to the shock absorber into heat and deformation energy when a predefined critical impact force is exceeded. The dampers can be made of rubber and placed between the end plates. In this case, the energy absorption can be reversed.

The object of the present invention is to create a better impact-absorbing element for motor vehicles that conforms to the requirements regarding deformation and strength, without weighing much.

### SUMMARY OF THE INVENTION

This object is achieved by an impact-absorbing element for motor vehicles that absorbs energy in a collision, which has a hollow metal tube closed by a mounting plate on one end and a wall at the back, with a plurality of inserts made of energy-absorbing plastic extending therebetween.

The combination of metal and plastic results in a better impact-absorbing element. By using plastic, it is possible to use metal tubes with thinner walls, thus reducing material consumption.

The metal tube has a cross section with at least four sides.

The metal tube can come in a variety of shapes.

The inserts are cylindrical. They can also come with a variety of cross sections.

These inserts have structures such as grooves and ring segments.

The ends of these inserts can be attached to the mounting plate and/or the end wall.

The inserts have a bore in the middle, into which a spike is pressed.

The inserts have projections at their ends that engage in corresponding recesses in the mounting plate and/or end wall.

The object is also obtained with a method for assembling the impact-absorbing elements, comprising the following steps:
Placing the inserts on, and attaching them to, the mounting plate,
Placing the metal tube on the mounting plate,
Attaching the metal tube to the mounting plate,
Closing off the metal tube surrounding the inserts with the end wall.

The functioning of the metal impact-absorbing element is improved by the energy-absorbing plastic insert.

### BRIEF DESCRIPTION OF THE DRAWINGS

FIG. 1 shows an impact-absorbing element where it is installed in the prior art,

FIGS. 2 and 3 show the impact-absorbing element obtained with the invention, and

FIGS. 4 and 5 show an exemplary insert.

### DETAILED DESCRIPTION

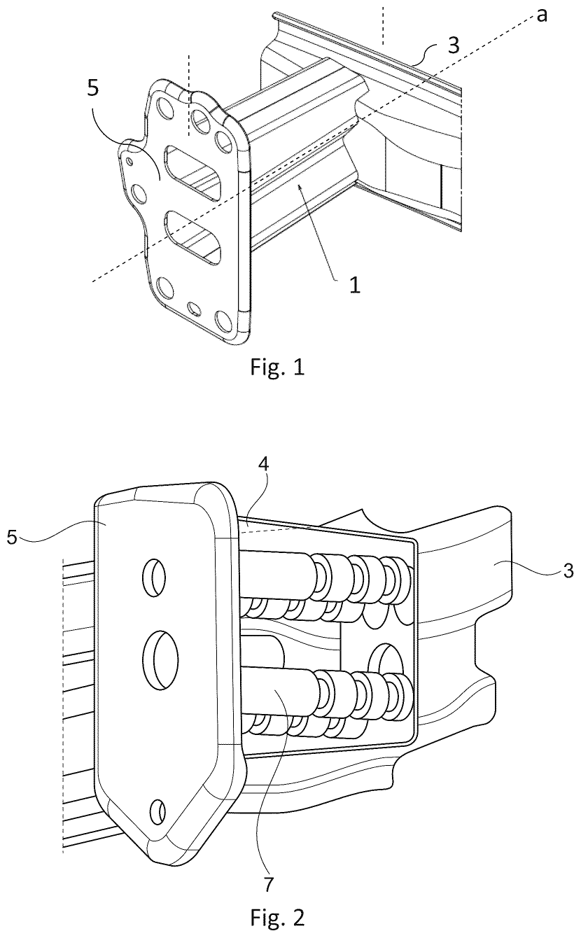

FIG. 1 shows where the impact-absorbing element is installed. The impact-absorbing element 1 is between the bumper 3 and a mounting plate 5. The mounting plate 5 forms a flange with which the impact-absorbing element is attached to the chassis, which is not shown. Because they can be easily produced, conventional impact-absorbing elements with a square or rectangular cross section are frequently used. Because an impact-absorbing element with a polygonal cross section is substantially stronger and more rigid, these impact-absorbing elements are becoming more popular. FIG. 1 shows an octagonal impact-absorbing element, extending along an axial axis a. The impact-absorbing element can have numerous sections that are formed by bending, rolling, stamping, pressing, drawing, hydroforming, molding, extrusion, cutting, and forging. These sections can be joined by welding, gluing, fastening, or other conventional joining technologies, thus forming a hollow chamber.

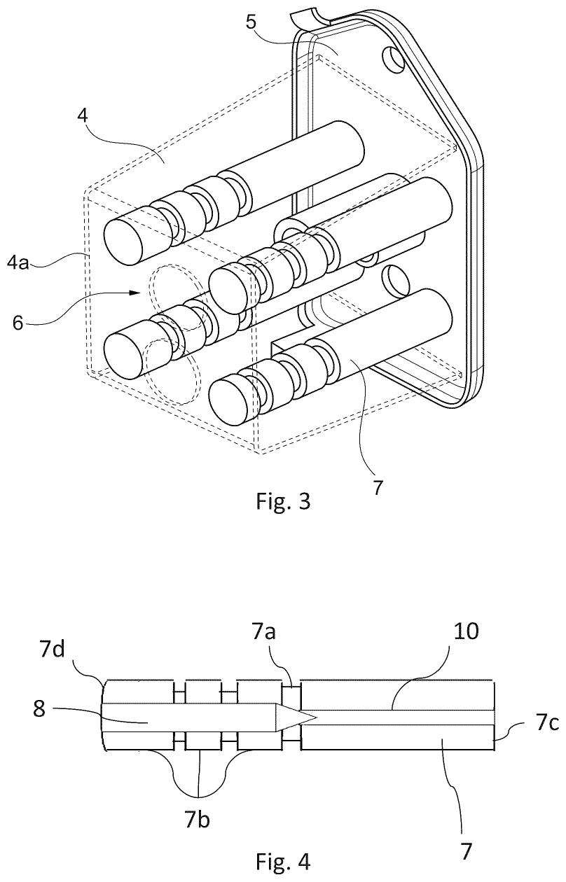

FIGS. 2 and 3 show the impact-absorbing element 1 obtained with the invention, composed of a metal tube 4 with arbitrary cross section shapes. Four inserts 7 can be seen in the hollow chamber 6 in the metal tube 4 in this exemplary embodiment.

The inserts 7 extend from the mounting plate 5 to the end wall 4a on the metal tube 4. The inserts are cylindrical, and are made of an energy-absorbing plastic. This plastic can be processed in a way that affects the elasticity of the inserts 7. In this exemplary embodiment, the inserts 7 have annular grooves 7a. These grooves can be of different widths. The ring segments 7b between the grooves 7a can be of the same or different lengths.

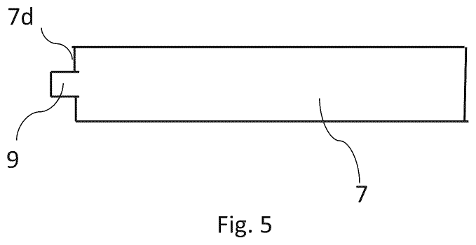

The ends 7d and 7c of the inserts 7 bear on the end walls of the metal tube 4. FIG. 4 shows the spike 8 that is inserted into the bore 10 running through the center of the insert 7. This spike affects the elasticity of the insert and can also be used to attach the end 7d to the mounting plate 5.

FIG. 5 shows, schematically, another means of attachment. The insert 7 has a projection 9 on the end 7d that is inserted in a corresponding hole on the mounting plate 5.

During assembly, all of the inserts 7 are first attached to or inserted in the mounting plate 5. A premade metal tube is then placed over the inserts 7 and connected to the mounting plate 5. If there is any tension, the inserts 7 also have to be attached to the end wall 4a. A receiver or small contour can be readily formed in the end wall for this.

The insert 7 can be attached to the mounting plate 5 in a variety of ways. Examples of this include the insert in a corresponding hole, or attaching it by means of a spike designed for this in the manner explained above.

1. An impact-absorbing element for a motor vehicle that absorbs energy in a collision, the impact-absorbing element comprising:
a metal tube extending between a mounting plate and an end wall to define a hollow chamber; and
a plurality of inserts comprised of energy-absorbing plastic disposed within the hollow chamber and each extending axially between the mounting plate and the end wall.

2. The impact-absorbing element according to claim 1, wherein the metal tube has a cross section with at least four sides.

3. The impact-absorbing element according to claim 1, wherein the plurality of inserts have a cylindrical cross-sectional shape.

4. The impact-absorbing element according to claim 3, wherein each of the plurality of inserts having a plurality of annular grooves to define a plurality of ring segments each disposed between adjacent ones of the plurality of grooves.

5. The impact-absorbing element according to claim 4, wherein each of the plurality of ring segments having the same axial length.

6. The impact-absorbing element according to claim 4, wherein each of the plurality of grooves having different widths and each of the plurality of ring segments having different axial lengths.

7. The impact-absorbing element according to claim 3, wherein each of the plurality of inserts defining a bore extending axially through a center of the respective insert, and wherein a spike is disposed in the bore.

8. The impact-absorbing element according to claim 7, wherein the spike attaches an end of the insert to the mounting plate.

9. The impact-absorbing element according to claim 3, wherein each of the plurality of inserts having a projection extending from one of their ends that engages a corresponding recess defined by the mounting plate to attach the plurality of inserts to the mounting plate.

10. The impact-absorbing element according to claim 1, wherein the plurality of inserts include four inserts.

11. A method for assembling the impact-absorbing element according to claim 1, comprising:
attaching an end of the plurality of inserts to the mounting plate;
placing the metal tube on the mounting plate and in surrounding relationship with the plurality of inserts,
attaching the metal tube to the mounting plate, and
closing off the metal tube with the end wall.
